(19) United States
(12) Patent Application Publication
(10) Pub. No.: US 2001/0038606 A1
(43) Pub. Date: Nov. 8, 2001

(54) Telecommunications system and xDSL controller

(75) Inventors: Naoki Furudate, Kawasaki (JP); Kiyoshi Taniguchi, Kanagawa (JP)

Correspondence Address: HELFGOTT & KARAS, P.C., 60th FLOOR, EMPIRE STATE BUILDING, NEW YORK, NY, 10118, US

(73) Assignee: FUJITSU LIMITED

(21) Appl. No.: 09/732,253

(22) Filed: Dec. 7, 2000

(30) Foreign Application Priority Data
Mar. 24, 2000 (JP) 2000-088488

(51) Int. Cl. H04J 1/16

(52) U.S. Cl. 370/217; 370/395

(57) ABSTRACT

A telecommunications system and xDSL controller which quickly switch line interface circuits without interrupting the communication when some line error condition is detected, providing higher service quality and improved maintainability. A working package comprises a plurality of line interface controllers which control signal transmission and reception over subscriber lines. A protection package is prepared as a replacement for the working package, which would be used if a line failure occurred at one of the line interface controllers in the working package. A line failure detector detects such a line failure, which causes a line switching unit to check the current operating status of each line interface controller. The line switching unit reroutes line signals from the working package to the protection package, based on the current operating status that is observed.

### BACKGROUND OF THE INVENTION

1. Field of the Invention

The present invention relates to telecommunications systems and xDSL interface equipment. More particularly, the present invention relates to a telecommunications system which provides telecommunication services over subscriber lines, as well as to a Digital Subscriber Line (xDSL) controller which enables high-speed digital transmission over an ordinary telephone line.

2. Description of the Related Art

To meet the increasingly high demand for fast and low-cost remote access capable of several hundred Kbps to several Mbps data transfer, some new technologies have been introduced to the market in recent years. The Digital Subscriber Line (xDSL) is considered to be one of the most promising technologies in this arena. The xDSL is a kind of modem technology which allows high-speed data transmission of several Mbps over ubiquitous copper-wire telephone infrastructures.

FIG. 16 shows a modem package installed in an xDSL system. This illustrated xDSL system 200 is constructed on an equipment rack 210 which accommodates a plurality of line interface modules to serve a number of telephone subscribers. Each such module, referred to herein as a “package” 201, contains a plurality of xDSL modem circuits 201-1 to 201-n, one for each subscriber line, to control digital data transmission and reception. The advancement in the electronic component technologies has made significant chip-size reduction and high-density mounting possible, resulting in the increased number of xDSL circuits per package. That is, today's technology allows a single modem package to serve more telephone subscribers.

The above xDSL system 200, however, has a problem in the quality of service, because it cannot recover from a failure without interrupting other normal signal traffic even when the failure is confined within a single xDSL circuit. Suppose, for example, that the xDSL modem 201-1 has failed for some reason. To fix the problem, it is necessary to stop the other xDSL modems 201-2 to 201-n, even though they are in service, so as to allow the maintenance person to pull the failed modem 201-1 out of the equipment rack 210 and replace it with an appropriate spare part. That is, in the conventional system, even a single point failure within a package would cause an unwanted effect to other channels that are operating normally, resulting in a problem of lower service quality and reliability.

### SUMMARY OF THE INVENTION

Taking the above into consideration, an object of the present invention is to provide a telecommunications system which quickly switches line interface circuits in a non-interruptive manner when some line error condition is detected, enabling higher service quality and improved maintainability.

It is another object of the present invention to provide an xDSL system which quickly switches line interface circuits in a non-interruptive manner when some line error condition is detected, enabling higher service quality and improved maintainability.

To accomplish the first object stated above, according to the present invention, there is provided a telecommunications system which provides telecommunication services over subscriber lines. This system comprises a working package, a protection package, and a communication management unit. The working package comprises a plurality of line interface controllers which control signal transmission and reception over each subscriber line. The protection package, prepared as a replacement for the working package, would be used if a line failure occurred at one of the line interface controllers in the working package. The communication management unit comprises a line failure detector and a line switching unit. The line failure detector detects a line failure, and the line switching unit monitors the current operating status of each line interface controller when a line failure is detected. It reroutes the line signals (i.e., reconfigures the line signal paths) from the working package to the protection package, based on the current operating status that is observed.

To accomplish the second object stated above, according to the present invention, there is provided an xDSL controller which offers high-speed digital network access. This xDSL controller comprises a working package, a protection package, and a communication management unit. The working package comprises a plurality of xDSL modems which control signal transmission and reception over each subscriber line. The protection package, prepared as a replacement for the working package, would be used if a line failure occurred at one of the xDSL modems in the working package. The communication management unit comprises a line failure detector and a line switching unit. The line failure detector detects a line failure, which makes the line switching unit monitor the current operating status of each xDSL modem. The line switching unit reroutes the line signals from the working package to the protection package, based on the current operating status that is observed.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a telecommunications system according to the present invention;

FIG. 2 is a diagram which shows the structure of an xDSL system;

FIG. 3 is a diagram which shows a typical hardware configuration of the xDSL system;

FIG. 4 is a diagram which shows a system configuration that is assumed in a preferred embodiment;

FIG. 5 is a diagram which shows the structure of an xDSL modem and its related circuitry;

FIG. 6 is a diagram which shows a start-up model of an xDSL modem;

FIG. 7 is a flowchart which shows a first type of line switching procedure based on the operating status of each line interface to user terminals;

FIG. 8 is a flowchart which shows a second type of line switching procedure based on the operating status of each line interface to user terminals;

FIG. 9 is a flowchart which shows a third type of line switching procedure based on the operating status of each line interface to user terminals;

FIG. 10 is a diagram which shows the concept of a system which performs line switching by monitoring ATM cell traffic;

FIG. 11 is a flowchart which shows a first type of line switching procedure based on the ATM cell traffic being monitored;

FIG. 12 is a flowchart which shows a second type of line switching procedure based on the ATM cell traffic being monitored;

FIG. 13 is a flowchart which shows a third type of line switching procedure based on the ATM cell traffic being monitored;

FIGS. 14 and 15 show a sequence diagram which explains how the line interfaces are switched to protection facilities; and

FIG. 16 is a diagram which shows a modem package installed in a conventional xDSL system.

### DESCRIPTION OF THE PREFERRED EMBODIMENTS

Preferred embodiments of the present invention will be described below with reference to the accompanying drawings.

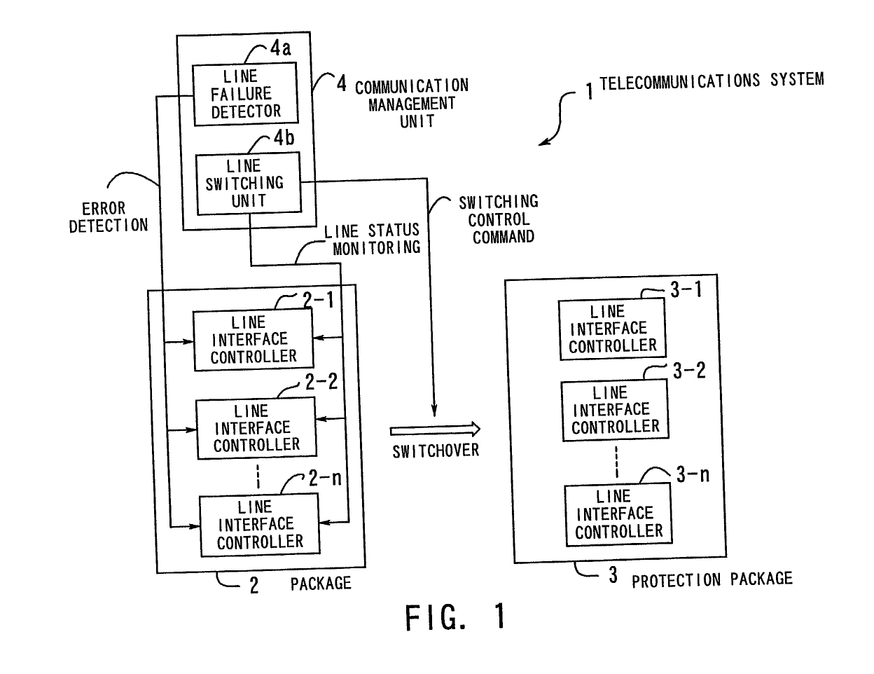

FIG. 1 is a conceptual view of a telecommunications system according to the present invention. The illustrated telecommunications system 1 provides telecommunication services over subscriber lines, being capable of automatically switching from working facilities to backup facilities when a line failure occurs. A package 2 accommodates a plurality of subscriber line interfaces. It actually integrates a plurality of line interface controllers 2-1 to 2-n each serving a single subscriber line. While the package 2 normally acts as working facilities, a protection package 3 is prepared for replacement of that working package 2 when it becomes inoperable because of some failure in its integral line interface controllers 2-1 to 2-n. The protection package 3 has a plurality of line interface controllers 3-1 to 3-n which are functionally equivalent to those in the working package 2.

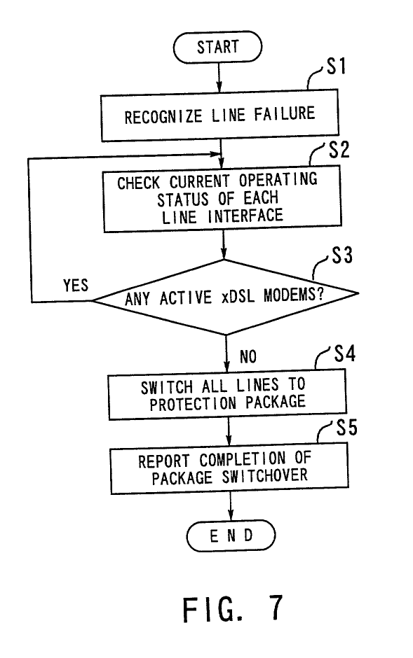

The communication management unit 4 comprises a line failure detector 4a and a line switching unit 4b. The line failure detector 4a detects a failure in the line interface controllers 2-1 to 2-n in the package 2. The line switching unit 4b monitors the operating status of the line interface controllers 2-1 to 2-n, and when a failure is detected, it switches the line traffic from the package 2 to the protection package 3, depending on the operating status observed. Suppose, for example, that the line interface controller 2-1 has failed. In this case, the line switching unit 4b reroutes the relevant traffic from the line interface controller 2-1 to an alternative line interface controller 3-1 in the protection package 3. In other words, the failed line interface controller 2-1 is logically replaced with the line interface controller 3-1. The details of this switching operation will be described later in FIGS. 7 and so on. When a line switching operation is completed, the communication management unit 4 so notifies the maintenance person by sending a message to his/her service terminal.

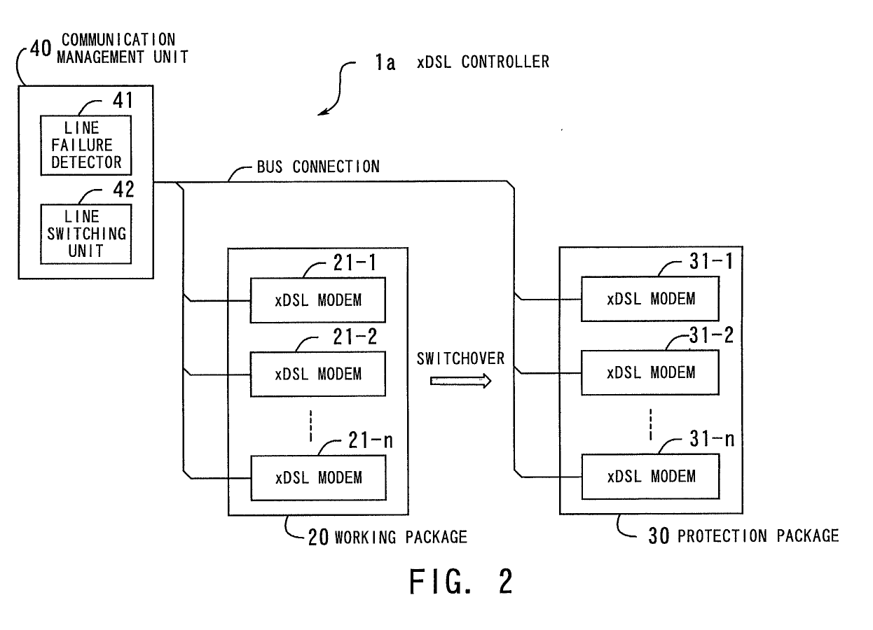

Referring to FIG. 2, the proposed telecommunications system 1 is now applied to an xDSL system having the Digital Subscriber Line Access Multiplex (DSLAM) function, which enables multiple DSL signals to be carried over a single transmission medium. The following section will describe the structure and operation of this xDSL system.

Illustrated in FIG. 2 is an xDSL controller 1a according to the present invention. This xDSL controller 1a is a multiplexing device intended for high-speed digital communication services using existing subscriber circuits. The xDSL controller 1a also provides automatic protection switching functions to make the system tolerant of line failures. An xDSL modem package 20, referred to herein as a “working package,” contains a plurality of xDSL modems 21-1 to 21-n to control signal transmission and reception over a plurality of subscriber lines simultaneously. These modem circuits are collectively referred to by a reference numeral “21,” where appropriate.

Besides the working package 20, the xDSL controller 1a has a protection package 30 for fault tolerance. The protection package 30 comprises xDSL modems 31-1 to 31-n which are functionally equivalent to the xDSL modems 21-1 to 21-n in the working package 20.

The xDSL controller 1a further comprises a communication management unit 40, which employs a line failure detector 41 and a line switching unit 42. This communication management unit 40 interacts with the working package 20 and protection package 30 through a bus connection. The line failure detector 41 detects a failure that may occur in the xDSL modems 21-1 to 21-n of the working package 20. The line switching unit 42, on the other hand, observes the operating status of the xDSL modems 21-1 to 21-n. When a failure is detected, it switches the line traffic from the working package 20 to the protection package 30, depending on the current operating status that is observed. When this line switching operation is completed, the communication management unit 40 so notifies the maintenance person by sending a message to his/her service terminal.

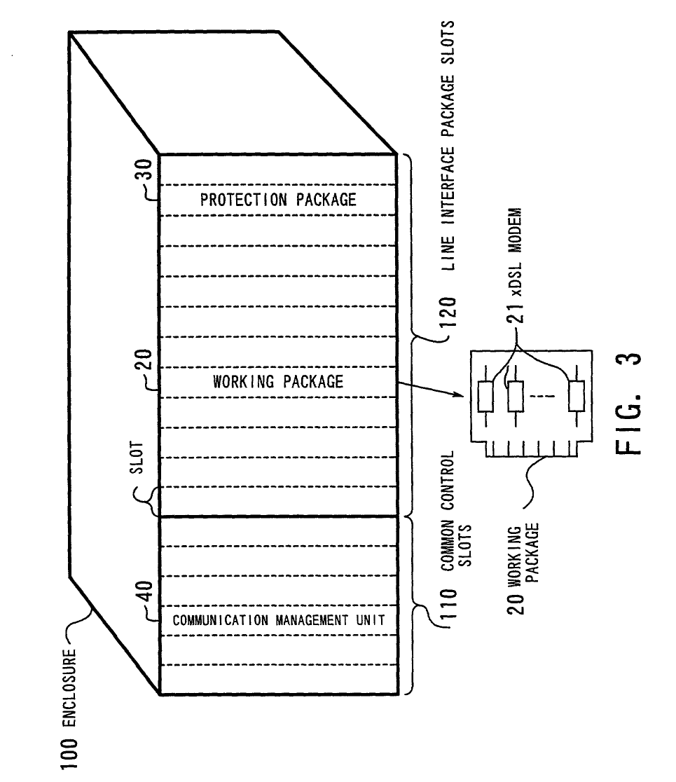

Referring now to FIG. 3, a typical physical structure of the xDSL controller 1=i a is illustrated. The enclosure 100 of the xDSL controller 1a has a plurality of card slots to install packages, which are divided into two groups: common control slots 110 and line interface package slots 120. The common control slots 110 accommodate common control packages including a CPU that performs administrative tasks for the entire system of packages. The communication management unit 40 of the present invention is among those common control packages. The line interface package slots 120, on the other hand, house a plurality of working packages 20 and protection packages 30.

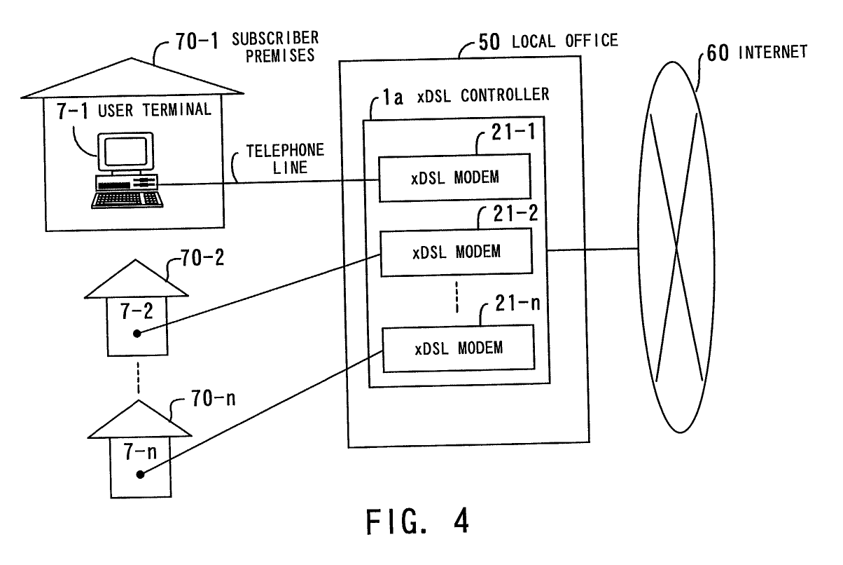

FIG. 4 illustrates a system configuration that is assumed in the embodiment being discussed. The proposed xDSL controller 1a is situated in a local office 50. Transmission signals of the xDSL modems 21-1 to 21-n are multiplexed into a higher-speed channel in the xDSL controller 1a and routed to the Internet 60 through a trunk circuit. The xDSL modems 21-1 to 21-n are also linked to their respective user terminals 7-1 to 7-n located in subscriber premises 70-1 to 70-n. While it is not shown in FIG. 4, each user terminal 7-1 to 7-n is equipped with an xDSL modem function. Those user terminals 7-1 to 7-n will be collectively referred to by a reference numeral “7,” where appropriate.

Such a system of FIG. 4 provides the customers with high speed network access services using the existing copper-wire telephone lines. In the case of Asymmetric DSL (ADSL) modems, every customer can receive 1.5 Mbps to 6 Mbps downstream signals and transmit 512 Kbps upstream signals, where the term “downstream” denotes the direction from the local office 50 to the subscriber premises 70-1 to 70-n, and the term “upstream” means the opposite. The bandwidth provided by ADSL is asymmetrical as such in the downstream and upstream directions.

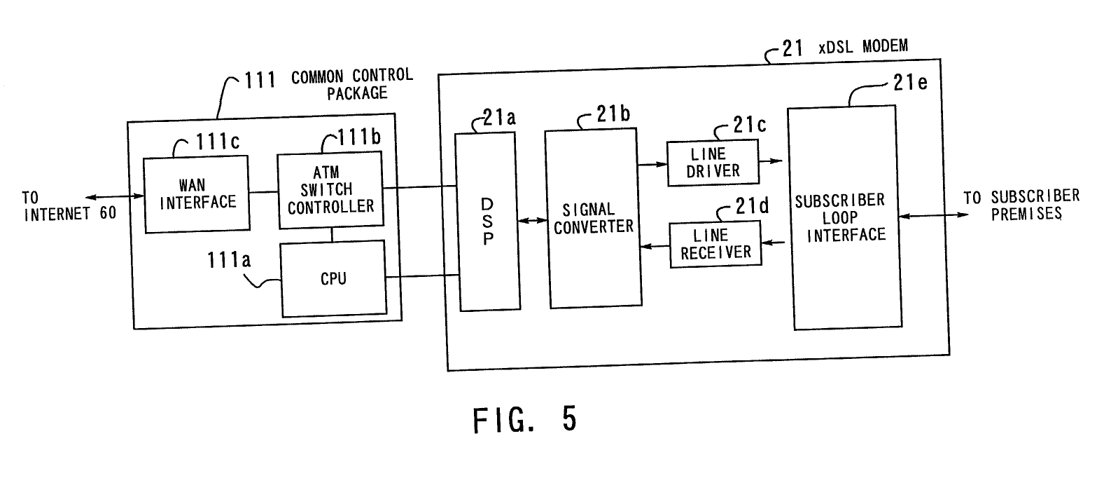

Referring next to FIG. 5, the detailed structure of an xDSL modem 21 will be discussed below. FIG. 5 is a block diagram of an xDSL modem 21 and its related circuitry. A common control package 111 is installed in one of the common control slots 110 explained in FIG. 3, which comprises a CPU 111a, an asynchronous transfer mode (ATM) switch controller 111b, and a wide area network (WAN) interface 111c.

The CPU 111a, including the communication management unit 40 of the present invention, performs administrative tasks for the entire system of the xDSL modems 21. The communication management unit 40 of the present invention is among those common control packages. The WAN interface 111c controls ATM interface functions, permitting access to the Internet 60. The ATM switch controller 111b controls ATM cell switching.

The xDSL modem 21 comprises a digital signal processor (DSP) 21a, a signal converter 21b, and a line driver 21c, a line receiver 21d, and a subscriber loop interface 21e. The DSP 21a processes ATM cells to be sent to or received from the Internet 60, as well as handling data to be sent to or received from the subscriber premises 70-1 to 70-n.

The signal converter 21b supplies the line driver 21c with a digital signal sent from the DSP 21a, converting it into an analog signal. It also supplies the DSP 21a with a digital signal converted from an analog signal that is received through the line receiver 21d. With the analog outgoing signal received from the 21b, the line driver 21c generates a signal to drive the subscriber line via the subscriber loop interface 21e. The line receiver 21d accepts an incoming analog signal from the subscriber loop interface 21e and supplies it to the signal converter 21b. The subscriber loop interface 21e takes in the incoming signal from the subscriber line and supplies it to the line receiver 21d, as well as feeding the outgoing signal from the line driver 21c to the two-wire subscriber line.

Referring back to FIG. 2, the line switching unit 42 monitors the operating status of the line interfaces that interconnect the xDSL modems 21-1 to 21-n and their corresponding user terminals 7-1 to 7-n. More specifically, the condition of each line is indicated in a register array that resides in its associated xDSL modem 21-1 to 21-n. With the information provided through such a register map, the line switching unit 42 can see whether each xDSL modem is idle or active.

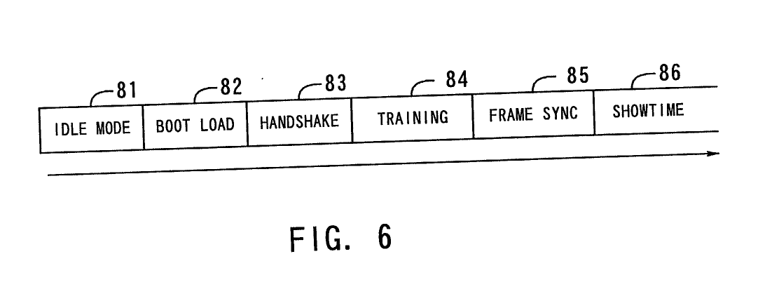

Referring next to FIG. 6, a startup sequence of an xDSL modem 21 is shown. This is a basic process when the xDSL modem 21 begins to communicate with its corresponding user terminal 7. In FIG. 6, the phase “IDLE MODE” 81 is an inactive phase where no particular task is executed. In the next phase “BOOT LOAD” 82, the physical layer interface is activated. The phase “HANDSHAKE” 83 is a phase where the xDSL modem 21 exchanges some information with the user terminal 7 to start up a communication session. In the subsequent phase “TRAINING” 84, the two parties transmit and receive test data for training their internal circuits. The phase “FRAME SYNC” 85 means a period when correct frame timings are sought and the frame synchronization is established. The last phase “SHOWTIME” 86 is a phase where the xDSL modem 21 is engaged in a data communication session with the user terminal 7. The aforementioned register array indicates in which phase each xDSL modem 21-1 to 21-n currently is.

The xDSL controller 1a performs protection switching according to the operating status of line interfaces that interconnect the xDSL modems 21-1 to 21-n and user terminals 7-1 to 7-n. To this end, the present invention proposes three methods as follows.

FIG. 7 is a flowchart which shows a first type of line switching procedure based on the operating status of each line interface to user terminals 7. In this flowchart, it is assumed that some failure has occurred in the xDSL modem 21-1 (FIG. 2).

(S1) The line failure detector 41 recognizes that some failure has happened to the xDSL modem 21-1 in the working package 20, which means that the communication with the user terminal 7-1 is disrupted.

(S2) The xDSL modems 21-2 to 21-n in the working package 20 provide information about how they are operating with their corresponding user terminals 7-2 to 7-n. The line switching unit 42 takes this information to check the current line conditions.

(S3) Based on the current operating status obtained at step S2, the line switching unit 42 determines whether any of the xDSL modems 21-2 to 21-n is engaged in an active communication session. If even a single modem circuit is found active, the process returns to step S2 to repeat the monitoring of operating status. If none of the xDSL modems 21-2 to 21-n is active, the process advances to step S4.

(S4) While the line signals have been handled by the xDSL modems 21-2 to 21-n of the working package 20, the line switching unit 42 now reroutes them to the other set of xDSL modems 31-1 to 31-n of the protection package 30 in their entirety.

(S5) When all lines are switched from the working package 20 to the protection package 30, the communication management unit 40 reports the completion to the maintenance person. He/she is now allowed to extract the faulty package 20 out of the enclosure 100 and tests it, without interrupting the communication service.

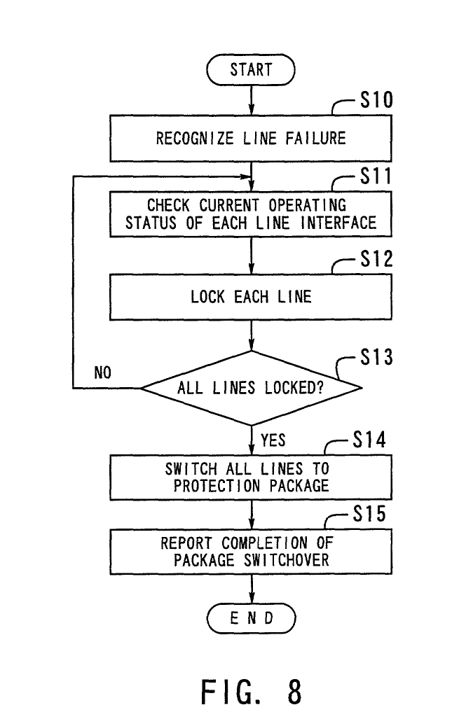

FIG. 8 is a flowchart which shows a second type of line switching procedure based on the operating status of each line interface to user terminals 7. In this flowchart, it is assumed that some failure has occurred at the xDSL modem 21-1 (FIG. 2).

(S10) The line failure detector 41 recognizes that some failure has happened to the xDSL modem 21-1 in the working package 20.

(S11) The line switching unit 42 checks how the xDSL modems 21-2 to 21-n in the working package 20 are currently operating with their corresponding user terminals 7-2 to 7-n.

(S12) The line switching unit 42 checks whether any of the remaining xDSL modems 21-2 to 21-n in the working package 20 is being idle or has just been released from a communication session. If such an inactive circuit is found, then the line switching unit 42 locks that inactive channel.

(S13) The line switching unit 42 determines whether all the remaining channels have been locked. If so, the process advances to step S14. If not, the process returns to step S11.

(S14) While the line signals have been handled so far by the xDSL modems 21-2 to 21-n in the working package 20, the line switching unit 42 now reroutes them to the other set of xDSL modems 31-1 to 31-n in the protection package 30 in their entirety.

(S15) When all lines are switched from the working package 20 to the protection package 30, the communication management unit 40 reports the completion to the maintenance person. He/she is now allowed to extract the faulty package 20 out of the enclosure 100 and tests it, without interrupting the communication service.

As seen from the above, the second type of line switching procedure differs from the first type in that it locks unused or idle facilities in the failed working package 20, thus preventing the remaining xDSL modems 21-2 to 21-n from being activated. When all the lines, except for the failed one, are locked, the control is switched from the package 20 to the protection package 30 at a time. Compared to the first type, the second type of line switching procedure can complete its job more efficiently and quickly.

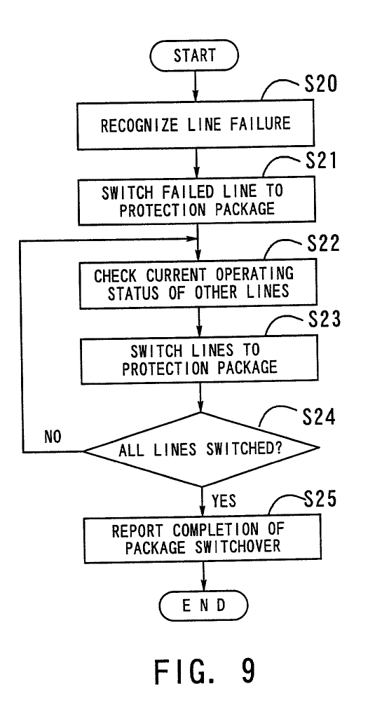

FIG. 9 is a flowchart which shows a third type of line switching procedure based on the operating status of each line interface to user terminals 7. In this flowchart, it is assumed that some failure has occurred at the xDSL modem 21-1 (FIG. 2).

(S20) The line failure detector 41 recognizes that some failure has happened to the xDSL modem 21-1 in the working package 20.

(S21) The line switching unit 42 switches the failed xDSL modem 21-1 in the working package 20 to its corresponding xDSL modem 31-1 in the protection package 30 by rerouting its subscriber line signal.

(S22) The line switching unit 42 monitors the remaining xDSL modems 21-2 to 21-n in the working package 20 to see how they are currently operating with their corresponding user terminals 7-2 to 7-n.

(S23) The line switching unit 42 checks whether any of the remaining xDSL modems 21-2 to 21-n in the working package 20 is unused or idle. If any inactive circuits are found, then the line switching unit 42 switches them individually to the protection package 30.

(S24) The line switching unit 42 determines whether all the remaining circuits have been switched to the protection package 30. If so, the process advances to step S25. If not, the process returns to step S22.

(S25) When all lines are switched from the working package 20 to the protection package 30, the communication management unit 40 reports the completion to the maintenance person. He/she is now allowed to extract the faulty package 20 out of the enclosure 100 and tests it, without interrupting the communication service.

As seen from the above, the third type of line switching procedure differs from the preceding two types in that the failed xDSL modem 21-1 is immediately replaced with its corresponding xDSL modem 31-1 in the protection package 30 when a failure is detected in it. The remaining lines are then switched from the xDSL modems 21-2 to 21-n in the working package 20 to the corresponding part of the protection package 30, as soon as they are recognized to be unused or idle (i.e., not engaged in any communication sessions). Because no locking operation is required, the third type of line switching procedure can complete its job more efficiently and quickly than the second type.

The next section will now presents another embodiment of the present invention, where the line switching unit 42 monitors ATM cell traffic to see how each xDSL modem 21 is operating.

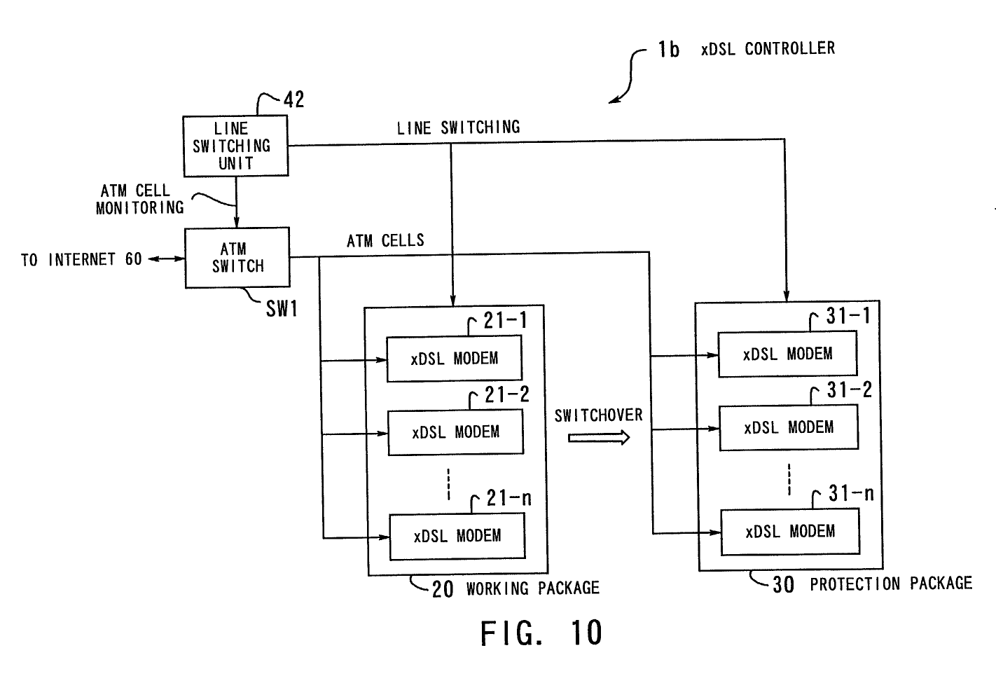

FIG. 10 shows the concept of a system which performs line switching based on the ATM cell traffic being monitored. The illustrated xDSL controller 1b comprises a line switching unit 42, an ATM switch SW1, a working package 20 of xDSL modems, and a protection package 30 of xDSL modems. The line switching unit 42 is coupled to the ATM switch SW1, so as to monitor the ATM cell traffic to/from the WAN (Internet 60) port. By doing so, the line switching unit 42 recognizes how each xDSL modem is operating. The ATM switch SW1 is implemented as an integral part of the ATM switch controller 111b described earlier in FIG. 5. Besides being coupled to the line switching unit 42, the ATM switch SW1 connects to the xDSL modems 21-1 to 21-n in the working package 20, as well as to the xDSL modems 31-1 to 31-n in the protection package 30. The ATM switch SW1 receives incoming ATM cells from the Internet 60 and recognizes their respective destination addresses. It switches the paths to the xDSL modems 21-1 to 21-n, so that the received ATM cells will be routed to their destinations.

Inside the xDSL controller 1b configured as above, the line switching unit 42 monitors valid ATM cell traffic through the ATM switch SW1, thereby recognizing how each xDSL modem is operating. If, for example, no valid ATM cell traffic to a certain xDSL modem is observed for a prescribed period, the line switching unit 42 regards the xDSL modem as being unused or idle. If some valid traffic is observed within a prescribed period, that xDSL modem is considered to be busy with an ongoing communication session. Although the ATM switch SW1 discussed above is provided as part of the common control package 111 in FIG. 5, separately from the working and protection packages 20 and 30, the invention is not limited to this particular arrangement. It should be appreciated that the working and protection packages 20 may employ an ATM switch of their own.

The xDSL controller 1b performs protection switching according to valid ATM cell traffic of each xDSL modem 21-1 to 21-n. To this end, the present invention proposes three methods as follows.

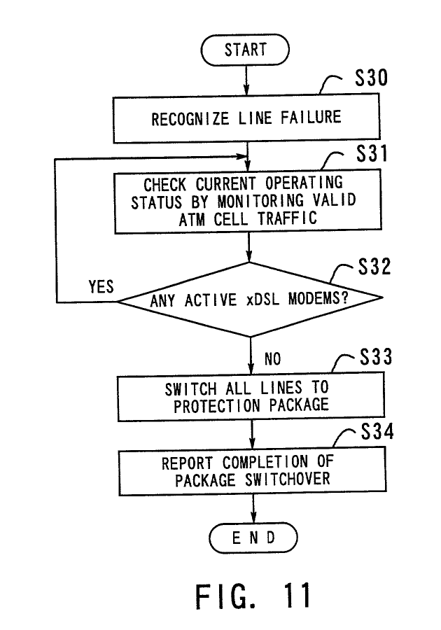

FIG. 11 is a flowchart which shows a first type of line switching procedure based on the ATM cell traffic being monitored. In this flowchart, it is assumed that some failure has occurred at the xDSL modem 21-1 shown in FIG. 10.

(S30) The line failure detector 41 recognizes that some failure has happened to the xDSL modem 21-1 in the working package 20.

(S31) By monitoring the valid ATM cell traffic to/from the xDSL modems 21-2 to 21-n in the package 20, the line switching unit 42 recognizes how each xDSL modem is currently operating.

(S32) Based on the current operating status obtained at step S31, the line switching unit 42 determines whether any of the xDSL modems 21-2 to 21-n is engaged in an active communication session. If even a single modem circuit is found active, the process returns to step S31 to repeat the monitoring of operating status. If none of the xDSL modems 21-2 to 21-n is active, the process advances to step S33.

(S33) While the line signals have been handled so far by the xDSL modems 21-2 to 21-n in the working package 20, the line switching unit 42 now reroutes them to the other set of xDSL modems 31-1 to 31-n in the protection package 30 in their entirety.

(S34) When all lines are switched from the working package 20 to the protection package 30, the communication management unit 40 reports the completion to the maintenance person. He/she is now allowed to extract the faulty package 20 out of the enclosure 100 and tests it, without interrupting the communication service.

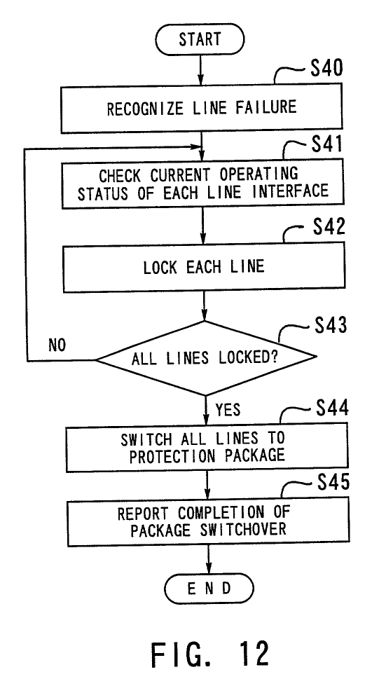

FIG. 12 is a flowchart which shows a second type of line switching procedure based on the ATM cell traffic being monitored. In this flowchart, it is assumed that some failure has occurred at the xDSL modem 21-1 shown in FIG. 10.

(S40) The line failure detector 41 recognizes that some failure has happened to the xDSL modem 21-1 in the working package 20.

(S41) By monitoring the valid ATM cell traffic to/from the xDSL modems 21-2 to 21-n in the package 20, the line switching unit 42 recognizes how each xDSL modem is currently operating.

(S42) The line switching unit 42 checks whether any of the remaining xDSL modems 21-2 to 21-n in the working package 20 is being unused or idle (or just has been released from a communication session). If such an inactive circuit is found, then the line switching unit 42 locks that channel.

(S43) The line switching unit 42 determines whether all the xDSL modems 21-1 to 21-n and their respective communication channels have been locked.

If so, the process advances to step S44. If not, the process returns to step S41.

(S44) While the line signals have been handled so far by the xDSL modems 21-2 to 21-n in the working package 20, the line switching unit 42 now reroutes them to the other set of xDSL modems 31-1 to 31-n in the protection package 30 in their entirety.

(S45) When all lines are switched from the working package 20 to the protection package 30, the communication management unit 40 reports the completion to the maintenance person. He/she is now allowed to extract the faulty package 20 out of the enclosure 100 and tests it, without interrupting the communication service.

As seen from the above, the second type of line switching procedure differs from the first type in that it locks unused or idle facilities in the failed working package 20, thus preventing the remaining xDSL modems 21-2 to 21-n from being activated. When all the lines, except for the failed one, are locked, the control is switched from the package 20 to the protection package 30 at a time. Compared to the first type, the second type of line switching procedure can complete its job more efficiently and quickly.

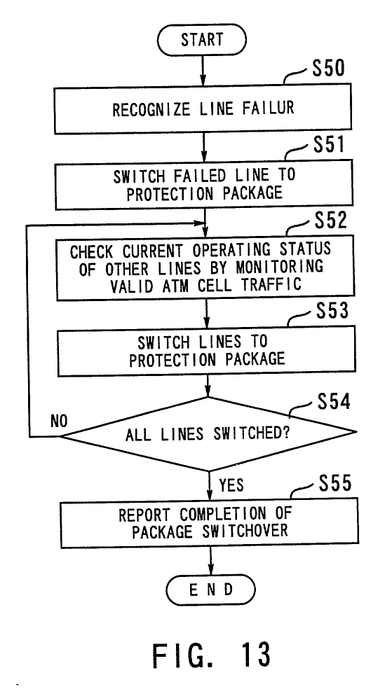

FIG. 13 is a flowchart which shows a third type of line switching procedure based on the ATM cell traffic being monitored. In this flowchart, it is assumed that some failure has occurred at the xDSL modem 21-1 shown in FIG. 10.

(S50) The line failure detector 41 recognizes that some failure has happened to the xDSL modem 21-1 in the working package 20.

(S51) The line switching unit 42 switches the failed xDSL modem 21-1 in the working package 20 to its corresponding xDSL modem 31-1 in the protection package 30 by rerouting its subscriber line signal.

(S52) By monitoring the valid ATM cell traffic to/from the remaining xDSL modems 21-2 to 21-n in the working package 20, the line switching unit 42 recognizes how each xDSL modem is currently operating.

(S53) The line switching unit 42 checks whether any of the remaining xDSL modems 21-2 to 21-n in the working package 20 is unused or idle. If any inactive circuits are found, then the line switching unit 42 switches them individually to the protection package 30.

(S54) The line switching unit 42 determines whether all the remaining circuits have been switched to the protection package 30. If so, the process advances to step S55. If not, the process returns to step S52.

(S55) When all lines are switched from the working package 20 to the protection package 30, the communication management unit 40 reports the completion to the maintenance person. He/she is now allowed to extract the faulty package 20 out of the enclosure 100 and tests it, without interrupting the communication service.

As seen from the above, the third type of line switching procedure differs from the preceding two types in that the failed xDSL modem 21-1 is immediately replaced with its corresponding xDSL modem 31-1 in the protection package 30 when a failure is detected in it. The remaining lines are then switched from the xDSL modems 21-2 to 21-n in the working package 20 to the corresponding part of the protection package 30, as soon as they are recognized to be unused or idle (i.e., not engaged in any communication sessions). Because no locking operation is required, the third type of line switching procedure can complete its job more efficiently and quickly than the second type.

While the above explanation has assumed that an ATM network is used as trunk facilities, the concept of the present invention is applicable to other network types. That is, the operating status of each xDSL modem is recognized by watching whatever data traffic, just like monitoring ATM cell traffic. Take an Internet Protocol (IP) network, for example. In this case, the line switching unit 42 monitors the IP packet traffic to see whether each xDSL modem is active.

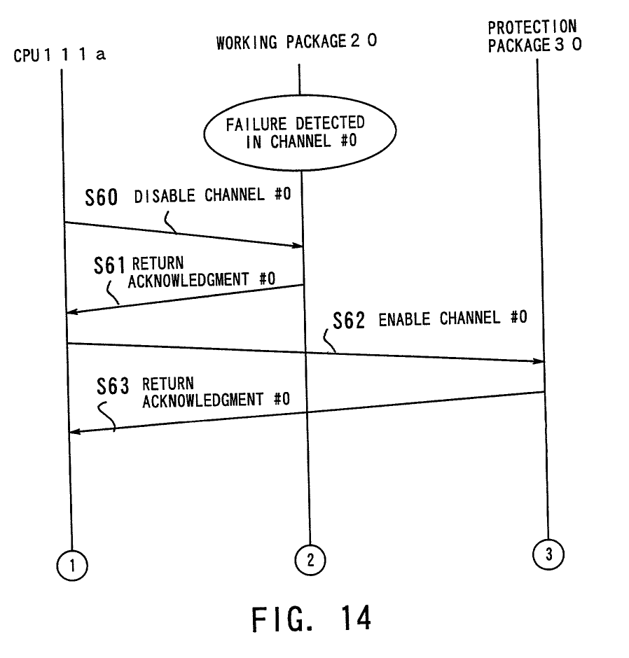

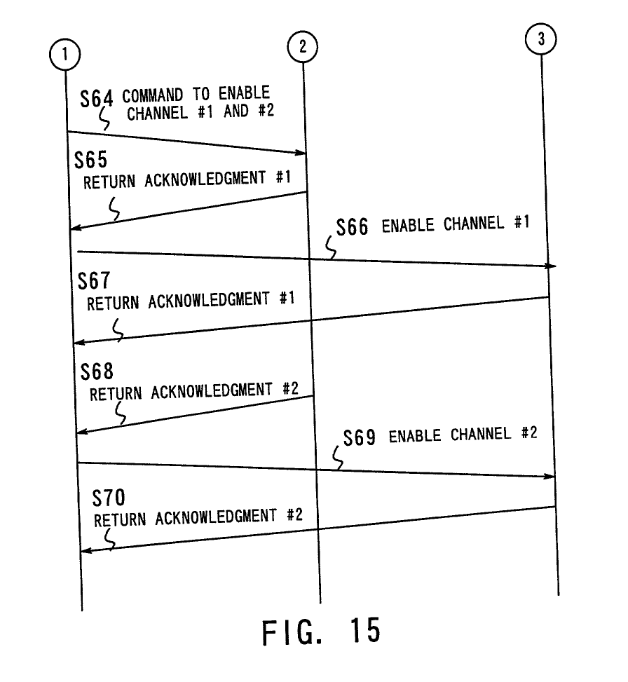

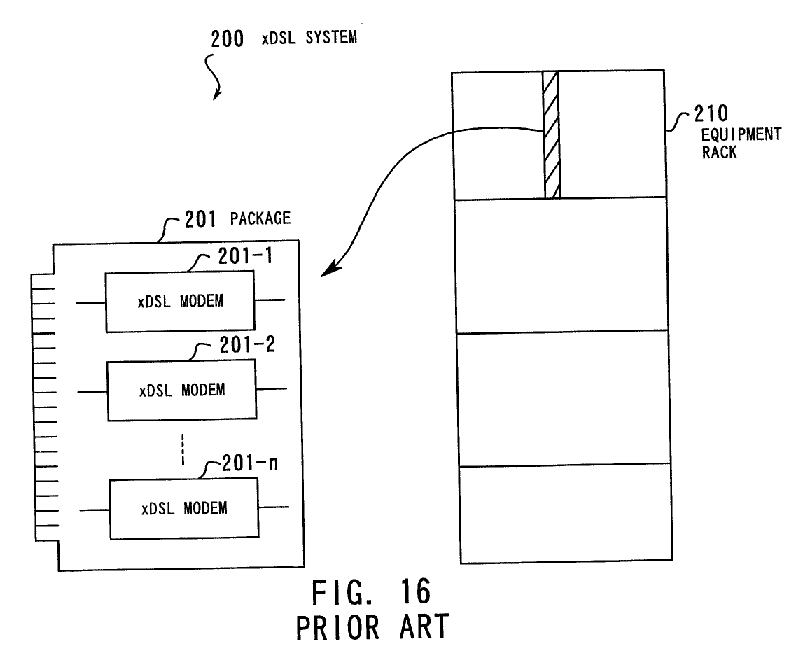

Referring next to a sequence diagram of FIGS. 14 and 15, the detailed sequence of the third type of line switching procedure discussed earlier in FIG. 9 will be explained. In this sequence diagram, it is assumed that the working package 20 houses three channels #0 to #2, and that a failure is found in the channel #0.

(S60) The CPU 111a, serving as the proposed communication management unit 40, controls the working package 20 to disable the failed channel.

(S61) The working package 20 returns an acknowledgment signal to the CPU 111a after disabling the failed channel.

(S62) Upon receipt of the acknowledgment from the working package 20, the CPU 111a controls the protection package 30 to enable a relevant channel (#0)

(S63) The protection package 30 enables its channel #0 circuit, returning acknowledgment to the requesting CPU 111a.

(S64) Upon receipt of the acknowledgment from the protection package 30, the CPU 111a controls the working package 20 to disable the other channels #1 and #2.

(S65) The working package 20 returns an acknowledgment signal to the CPU 111a when the channel #1 exits from the “SHOWTIME” state.

(S66) The CPU 111a controls the protection package 30 to enable the channel #1.

(S67) The protection package 30 enables its channel #1 circuit, returning an acknowledgment signal to the requesting CPU 111a.

(S68) The working package 20 returns another acknowledgment signal to the CPU 111a when the channel #2 exits from the “SHOWTIME” state.

(S69) The CPU 111a controls the protection package 30 to enable the channel #2.

(S70) The protection package 30 enables its channel #2 circuit, returning an acknowledgment signal to the requesting CPU 111a.

As a result of the above sequence, all the channels #0 to #2 will be operated on the protection package 30, thus allowing the maintenance person to pull out the failed package 20.

The above discussion will now be summarized as follows. According to the present invention, the proposed telecommunications system 1 and xDSL controllers 1a and 1b perform a line switching operation to switch a failed package to a protection package when a failure is detected, depending on the monitored information about how the line interface controllers, or xDSL modems, are currently operating. This feature enables the system to quickly recover from failure without disrupting the ongoing communication sessions over the other user channels, thus providing higher service quality and better maintainability.

While the invention has been discussed so far with a focus on xDSL multiplexers, it is not intended to limit the scope of the invention to this particular type of equipment. The present invention may also be applied to any other type of multiplexer system, such as the ATM-Passive Optical Network (ATM-PON) and other optical access networks.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A telecommunications system which provides telecommunication services over subscriber lines, comprising:
(a) a working package comprising a plurality of line interface control means for controlling signal transmission and reception over each subscriber line;
(b) a protection package being prepared as a replacement for said working package, which is intended for use in case of a line failure detected at one of said plurality of line interface control means; and
(c) a communication management unit comprising:
line failure detecting means for detecting the line failure, and
line switching means for monitoring a current operating status of each of said plurality of line interface control means when the line failure is detected, and rerouting line signals from said working package to said protection package, based on the current operating status being observed.

2. The telecommunications system according to claim 1, wherein said line switching means monitors how said plurality of line interface control means are operating with corresponding user terminals.

3. The telecommunications system according to claim 2, wherein said line switching means reroutes the line signals from said working package to said protection package all at once, when said plurality of line interface control means are all inactive.

4. The telecommunications system according to claim 2, wherein said line switching means locks said line interface control means in said working package that are unused or idle, and reroutes the line signals from said working package to said protection package all at once when all of said line interface control means, except for the failed one, are locked.

5. The telecommunications system according to claim 2, wherein said line switching means reroutes the line signals of the failed line interface control means from said working package to said protection package, and reroutes the remaining line signals individually from said working package to said protection package when the remaining line interface control means in said working package are found unused or idle.

6. The telecommunications system according to claim 1, wherein said line switching means monitors ATM cell traffic to obtain the current operating status of each line interface control means.

7. The telecommunications system according to claim 6, wherein said line switching means reroutes the line signals from said working package to said protection package all at once, when said plurality of line interface control means are all inactive.

8. The telecommunications system according to claim 6, wherein said line switching means locks said line interface control means in said working package that are unused or idle, and reroutes the line signals from said working package to said protection package all at once when all of said line interface control means, except for the failed one, are locked.

9. The telecommunications system according to claim 6, wherein said line switching means reroutes the line signal of the failed line interface control means from said working package to said protection package, and reroutes the remaining line signals individually from said working package to said protection package when the remaining line interface control means in said working package are found unused or idle.

10. The telecommunications system according to claim 1, wherein said communication management unit notifies a maintenance person of the completion of said rerouting of the line signals from said working package to said protection package.

11. A Digital Subscriber Line (xDSL) controller which provides high-speed digital network access, comprising:
(a) a working package comprising a plurality of xDSL modems for controlling signal transmission and reception over each subscriber line;
(b) a protection package being prepared as a replacement for said working package, which is intended for use in case of a line failure detected at one of said plurality of xDSL modems; and
(c) a communication management unit comprising:
line failure detecting means for detecting the line failure, and
line switching means for monitoring a current operating status of each of said plurality of xDSL modems when the line failure is detected, and rerouting line signals from said working package to said protection package, based on the current operating status being observed.

12. The xDSL controller according to claim 11, wherein said line switching means monitors how said plurality of xDSL modems are operating with corresponding user terminals.

13. The xDSL controller according to claim 12, wherein said line switching means reroutes the line signals from said working package to said protection package all at once, when said plurality of xDSL modems are all inactive.

14. The xDSL controller according to claim 12, wherein said line switching means locks said xDSL modems in said working package that are unused or idle, and reroutes the line signals from said working package to said protection package all at once, when all of said xDSL modems, except for the failed xDSL modem, are locked.

15. The xDSL controller according to claim 12, wherein said line switching means first reroutes the line signal of the failed xDSL modem from said working package to said protection package, and then reroutes the remaining line signals individually from said working package to said protection package when the remaining xDSL modems in said working package are found unused or idle.

16. The xDSL controller according to claim 11, wherein said line switching means monitors ATM cell traffic to obtain the operating status of said plurality of xDSL modems.

17. The xDSL controller according to claim 16, wherein said line switching means reroutes the line signals from said working package to said protection package all at once, when said plurality of xDSL modems are all inactive.

18. The xDSL controller according to claim 16, wherein said line switching means locks said xDSL modems in said working package that are unused or idle, and reroutes the line signals from said working package to said protection package all at once, when all of said xDSL modems, except for the failed xDSL modem, are locked.

19. The xDSL controller according to claim 16, wherein said line switching means first reroutes the line signal of the failed xDSL modem from said working package to said protection package, and then reroutes the remaining line signals individually from said working package to said protection package when the remaining xDSL modems in said working package are found unused or idle.

20. The xDSL system according to claim 11, wherein said communication management unit notifies a maintenance person of the completion of said rerouting of the line signals from said working package to said protection package.
